(19) United States
(12) Patent Application Publication
(10) Pub. No.: US 2023/0413057 A1
(43) Pub. Date: Dec. 21, 2023

(54) METHOD AND APPARATUS FOR MITIGATING MAN IN THE MIDDLE ATTACK IN WIRELESS NETWORK

(71) Applicant: SAMSUNG ELECTRONICS CO., LTD., Suwon-si, Gyeonggi-do (KR)

(72) Inventors: Rajavelsamy RAJADURAI, Suwon-si (KR); Nivedya PARAMBATH SASI, Suwon-si (KR); Rohini RAJENDRAN, Suwon-si (KR)

(21) Appl. No.: 18/252,501

(22) PCT Filed: Nov. 10, 2021
(86) PCT No.: PCT/KR2021/016367

§ 371 Date: May 10, 2023

(30) Foreign Application Priority Data
Nov. 10, 2020 (IN) 202041048973
Oct. 25, 2021 (IN) 202041048973

(51) Int. Cl. H04W 12/121

(52) U.S. Cl. CPC H04W 12/121

(57) ABSTRACT

The present disclosure relates to a communication method and system for converging a 5th Generation (5G) communication system for supporting higher data rates beyond a 4th Generation (4G) system with a technology for Internet of Things (IoT).

The method includes comparing plurality of parameters (e.g. TAI) received in message (e.g. initial NAS message, registration request, first protected NAS message) from UE and plurality of parameters (e.g. TAI) broadcasted/received/stored by AMF entity and/or genuine gNB. AMF entity and/or genuine gNB sends an accept message (e.g. NAS accept) or reject message (e.g. NAS reject, RRC reject or RRC reconfiguration.) with appropriate error cause value to UE to mitigate the MitM attack. Based on received message from AMF entity and/or genuine gNB, UE detects that UE is camped on genuine gNB or fake gNB. UE performs action(s) (e.g. cell reselection), when UE is camped on fake gNB/eNB to mitigate MitM attack.

### CROSS-REFERENCE TO RELATED APPLICATIONS

This application is a 371 of International Application No. PCT/KR2021/016367 filed Nov. 10, 2021, which claims priority to Indian Patent Application No. 202041048973, filed Oct. 25, 2021, and Indian Patent Application No. 202041048973, filed Nov. 10, 2020, the disclosures of which are herein incorporated by reference in their entirety.

### BACKGROUND

### 1. Field

The present disclosure relates to a wireless network, and more specifically related to a method and an apparatus for mitigating a man in the middle (MitM) attack in a wireless network.

### 2. Description of Related Art

To meet the demand for wireless data traffic having increased since deployment of 4th Generation (4G) communication systems, efforts have been made to develop an improved 5th Generation (5G) or pre-5G communication system. Therefore, the 5G or pre-5G communication system is also called a ‘Beyond 4G Network’ or a ‘Post long term evolution (LTE) System’. The 5G communication system is considered to be implemented in higher frequency (mmWave) bands. e.g., 60 GHz bands, so as to accomplish higher data rates. To decrease propagation loss of the radio waves and increase the transmission distance, the beamforming, massive Multiple-Input Multiple-Output (MIMO), Full Dimensional MIMO (FD-MIMO), array antenna, an analog beam forming, large scale antenna techniques are discussed in 5G communication systems. In addition, in 5G communication systems, development for system network improvement is under way based on advanced small cells, cloud Radio Access Networks (RANs), ultra-dense networks. Device-to-Device (D2D) communication, wireless backhaul, moving network, cooperative communication. Coordinated Multi-Points (CoMP), reception-end interference cancellation and the like. In the 5G system, Hybrid FSK (Frequency Shift Keying) and QAM (Quadrature Amplitude Modulation) Modulation (FQAM) and sliding window superposition coding (SWSC) as an advanced coding modulation (ACM), and Filter Bank Multi Carrier (FBMC), Non-Orthogonal Multiple Access (NOMA), and Sparse Code Multiple Access (SCMA) as an advanced access technology have been developed.

The Internet, which is a human centered connectivity network where humans generate and consume information, is now evolving to the Internet of Things (IoT) where distributed entities, such as things, exchange and process information without human intervention. The Internet of Everything (IoE), which is a combination of the IoT technology and the Big Data processing technology through connection with a cloud server, has emerged. As technology elements, such as “sensing technology”, “wired/wireless communication and network infrastructure”, “service interface technology”, and “Security technology” have been demanded for IoT implementation, a sensor network, a Machine-to-Machine (M2M) communication, Machine Type Communication (MTC), and so forth have been recently researched. Such an IoT environment may provide intelligent Internet technology services that create a new value to human life by collecting and analyzing data generated among connected things. IoT may be applied to a variety of fields including smart home, smart building, smart city, smart car or connected cars, smart grid, health care, smart appliances and advanced medical services through convergence and combination between existing Information Technology (IT) and various industrial applications.

In line with this, various attempts have been made to apply 5G communication systems to IoT networks. For example, technologies such as a sensor network, MTC, and M2M communication may be implemented by beamforming, MIMO, and array antennas. Application of a cloud RAN as the above-described Big Data processing technology may also be considered to be as an example of convergence between the 5G technology and the IoT technology.

In general, when a User Equipment (UE) operates in an active state (i.e. RRC-Connected state), a location of the UE is known by a network at cell level based on cell granularity. However, when the UE operates in an idle state (i.e. Radio Resource Control (RRC) idle state), the location of the UE is known by the network at a Tracking Area (TA) level based on a TA granularity instead of the cell level. A wireless network operator defines a group of neighborhoods Next Generation NodeB(s) (gNBs) and/or Evolved NodeB(s) (eNBs) as a TA. For example, the gNBs/eNBs in “A-neighborhood” are defined as TA1, the gNBs/eNBs in “B-neighborhood” are defined as TA2, the gNBs/eNBs in “C-neighborhood are defined as TA3”, and soon. A Tracking Area Identity (TAI) consists of a Public Land Mobile Network Identifier (PLMN ID) and a Tracking Area Code (TAC). The PLMN ID is a combination of a Mobile Country Code (MCC) and a Mobile Network Code (MNC). The TAC is a unique code that each wireless network operator assigns to each TA (e.g. TAC1=0x0001).

If there is data traffic heading towards the UE in the idle state (for example, if someone sends a text message to the UE), the network must wake up the UE so that the data can be received. Consider, the UE is in a neighborhood where the network considers the UE is present in the TA3. As a result, when the network needs to wake up the UE because some data for the UE has been received. Further, the network sends a paging message to each gNB/eNB in the TA3. The paging message is then broadcast by each gNB/eNB over a radio link to waking up the UE. When the UE is in the idle state, the UE periodically wakes up to check for paging messages and to see if there is any incoming data from any gNB/eNB. To determine under which TA a particular UE is located in, the network must have to update location information about UEs in the idle state. Every time the UE moves between TAs (e.g. TA1, TA2, TA3, etc.), and the UE notifies the network of UE's current location by sending a registration request/Tracking Area Update (TAU) request.

In case of a 5th Generation (5G) mobile network, a registration area management includes functions to allocate and reallocate a registration area to the UE. The registration area is managed according to an access type (e.g., 3rd Generation Partnership Project (3GPP) access or Non-3GPP access). When the UE registers with the network over the 3GPP access, an Access and Mobility Management Function (AMF) allocates a set of tracking areas in a TAI list to the UE. When the AMF allocates the registration area (i.e. the set of tracking areas in the TAI List) to the UE the AMF may consider various information (e.g. Mobility Pattern and Allowed/Non-Allowed Area). The registration area is a set of TAs in the TAI list that have been specifically grouped for a particular UE. The selection of the TAs that comprise the UE's registration area was chosen to reflect the UE's movements while taking the UE's mobility pattern into account.

When the UE connects/registers to the network, the UE obtains the TAI list. The TAI list shows the tracking areas in which the network believes the UE is located and within which the UE can travel without requesting the TAU request message. For example, if the TAI list contains TAC1, TAC2, the UE is not required to send the registration request/TAU request message to the network as long as the UE remains in TA1 or TA2, but the UE is required to send the registration request/TAU request message to the network when the UE moves to a new TA other than TAI or TA2 (say TA3). The network is supposed to provide the UE with a new TA list that reflects the specifics of the UE's move (e.g., new location, moving speed, and so on) for more efficient paging.

Certain problems are detected in the existing system when a fake gNB/eNB with TAI not in the UE's allowed “TAI list” appears and the UE ends up camping on the fake gNB/eNB, the UE sends the registration request/TAU request message. The fake gNB/eNB sends a registration reject message/tracking area reject message in response to the registration request message/TAU request message. A “cause #15” is a reason for rejection (i.e. no suitable cells in the tracking area). The fake gNB/eNB changes its TA to the TA that was in the UE's allowed TAI list after sending the registration reject message/tracking area reject message, making it (the TAI) forbidden. Similarly, any TAIs can be further added to a “forbidden TAs list”. As described in 3GPP Technical Specification (TS) 24.501 and 24.301, if the UE received the reject message with “cause #15”, the UE would clear its “TAI list” and try to find a suitable cell in another TA. If Reference Signal Received Power (RSRP) & Reference Signal Received Quality (RSSQ) of the fake gNB/eNB is higher than a genuine gNB/eNB, the UE may camp on the fake gNB/eNB again. Since the “TAT list” of the UE is cleared, and the UE will further send the registration request/TAU message again. If the fake gNB/eNB rejects the registration request/TAU message, the TAI would be added into the “forbidden TAs list”. A similar procedure can be repeated to add all the TAIs into the UE's “forbidden TAs list”. Once all the TAIs in the area have been added into “forbidden TAs list”, as a result of a downgraded attack the UE will connect to 3G/2G network (e.g. 4G network to 3G/2G network).

Another way of describing the problems, assuming the case where the UE has an allowed TAI list (i.e. TAI1, TA12, and TA13). The genuine gNB/eNB supports TAI4. The fake gNB/eNB acting as a man-in-the-middle (e.g. Man in the Middle (MitM)) between the UE and the genuine gNB/eNB that broadcasts as the fake gNB/eNB supports the TAI1 and TAI2. Then, the UE will try to access the genuine gNB/eNB via the fake gNB/eNB. The gNB will send the TAI4 to the AMF. The AMF checks if the TAI4 is in the allowed TAI list and the registration request will be rejected by the AMF by cause #15 and the AMF will send a new TAI list and most probably the same allowed TAI list. The UE will have the same allowed TAT list and since the cell reselection conditions have not changed, the UE will remain on the same cell (cell of the fake gNB/eNB) and attempt registration again and the same cycle will be repeated. i.e., the UE will go into a loop of registration attempts and never succeed.

In another scenario, if the UE has an allowed TAI list (i.e.TAI1, TAI2, and TAI3). The genuine gNB/eNB supports the TAI3. The fake gNB/eNB acting as a man-in-the-middle between the UE and the genuine gNB/eNB that broadcasts as it supports TAI25 (e.g., an unauthorized base station owned and operated by an attacker (unauthorized entity) that masquerade/deception as the base station owned and operated by the mobile network operator and exploits security weaknesses to mount security and privacy attacks (like Denial of service (DoS)) on the UE and the network). Then, the UE will try to access the network via the genuine gNB/eNB and the fake gNB/eNB. The gNB will send the TAI3 to the AMF. The AMF checks if the TA13 is in the allowed TA list and the registration request will be accepted by the AMF and the AMF will not send a new TAI list, as TAI3 is part of the TAI list provided to the UE. However, whenever the UE reads a System Information Block (SIB) (specifically the TA of the cell), then the UE keep sending the registration message (for example, Mobility Registration Update: UE re-registration when entering new TA outside the TAI List), as broadcasted TAI (TA125) is not part of the allowed TAI list (TAI1. TA12, and TAI3). Broadcast of the fake TAI by the fake gNB/eNB will perform mobility registration update procedure (even if the UE is in the RM-REGISTERED state), as the current TAI of the serving cell (as per TS 37.340) is not in the list of TAIs that the UE has received from the network to maintain the registration and enable the AMF to page the UE. Sending the Registration message often without any benefit, will create overhead in the AMF and also led to unnecessary UE state transition and battery power consumption. Further, if the UE sends the last visited TAI as TAI25 to the AMF, then it will create ambiguity in producing the registration area for the UE.

Thus, it is desired to address the above-mentioned disadvantages or other shortcomings or at least provide a useful alternative for mitigating the MitM attack in the wireless network.

### SUMMARY

The principal object of the embodiments herein is to mitigate a Man in the Middle (MitM) attack in a wireless network by comparing, by an AMF and/or genuine gNB/eNB, a plurality of parameters (e.g. TA1, CAG ID, etc.) received in a message (e.g. initial NAS message, registration request, first protected NAS message) from a User Equipment (UE) and a plurality of parameters (e.g. TA1, CAG ID, etc.) broadcasted/received/stored by the AMF and/or genuine gNB/eNB. The AMF and/or genuine gNB/eNB sends accept message (e.g. NAS accept) or reject message (e.g. NAS reject, RRC reject or RRC reconfiguration, registration reject, etc.) with appropriate error cause value to the UE to mitigate the MitM attack.

Another object of the embodiment herein is to include, by the UE, the plurality of parameters in the message and send the message to the AMF and/or genuine gNB/eNB. The UE receives the accept message or reject message with appropriate error cause value from the AMF and/or genuine gNB/eNB. Based on the received message from the AMF and/or genuine gNB/eNB, the UE detects that the UE is camped on a genuine gNB/eNB or a fake gNB/eNB. The UE performs an action(s) (e.g. cell reselection. RRC re-establishment procedure, etc.), when the UE is camped on the fake gNB/eNB, to mitigate the MitM attack. As a result, by selecting the genuine gNB/eNB, the UE can avoid unnecessary UE state transition/signalling and reduce battery power consumption.

Another object of the embodiment herein is to send, by the UE in inactive state the TAI in an RRC resume request and the gNB/eNB to respond with the TAI in a protected or unprotected response message (in response to the resume request). It becomes difficult to launch the attack because it is extremely difficult for an attacker to modify the TAI in both the request and response messages (if the response is unprotected). When the UE detects a difference between the TAI sent in the RRC resume request message and the TAI of the genuine gNB/eNB received in the protected or unprotected response message, the UE suspects an air interface vulnerability and proceeds to re-establish the RRC connection by going for the cell reselection.

Another object of the embodiment herein is to initiate, by the UE, emergency services under the worst circumstances. During this time, the UE does not delete the “forbidden TAs list” and can search for an appropriate allowed TA cell to camp on.

Another object of the embodiment herein is to add, by the UE, current TAI to a forbidden list but not erase the entire TAI list for a particular time window unless a periodic update has occurred on receiving the registration reject with “cause #15” from the network or switching the UE off and on, or removing and re-inserting a UMTS Subscriber Identity Module (USIM)/a Universal Integrated Circuit Card (UICC) from/in the UE. In other words, the UE should not delete the “Allowed TAIs list” unless the UE receives a new “Allowed TAIs list” with one or more TAI that is not the same as in the “Old Allowed TAIs list.”

Another object of the embodiment herein is to maintain, by the UE, a list of mapping between allowed Physical Cell ID (PCI) and CAG ID from Automatic Neighbours Relation (ANR) Table and the TAI for all available neighbouring TAI.

Another object of the embodiment herein is to send, by the AMF, the TAI of the genuine gNB broadcasting its TAI when the UE receives the reject message. The UE determines whether any PCI and CAG ID in the ANR mapping list is linked to the TAI received from the AMF. If not, the UE should add that TA to the “forbidden TAs list” and continue with the cell reselection.

Another object of the embodiment herein is to maintain, by the UE, a NAS security context as well as an Access Stratum (AS) security context while also moving out of the cell when an adversary acting as MitM is detected. It means that UE cannot delete the existing NAS and AS security contexts unless it finds a new genuine cell to camp on.

Accordingly, embodiments herein disclose a method for mitigating a Man in the Middle (MitM) attack in a wireless network. The method includes receiving, by an Access and Mobility Management Function (AMF) entity, an initial Non-Access Stratum (NAS) message from a User Equipment (UE) and/or an N2 message (e.g. control plane interface between an Access Network (gNB) and 5GC (AMF).) from a genuine Next Generation NodeB (gNB). Further, the method includes determining, the AMF entity, a plurality of parameters received in the initial NAS message and a plurality of parameters received in the N2 message. Further, the method includes determining, the AMF entity, whether the plurality of parameters received in the initial NAS message matches with the plurality of parameters received in the N2 message. Further, the method includes sending a NAS accept message with appropriate indication to the UE in response to determining that the plurality of parameters received in the initial NAS message matches with the plurality of parameters received in the N2 message. Further, the method includes sending a NAS reject message with appropriate error cause value to the UE to mitigate the MitM attack in response to determining that the plurality of parameters received in the initial NAS message does not match with the plurality of parameters received in the N2 message.

In an embodiment, the plurality of parameters includes a Tracking Area Identity (TAI) and/or a Closed Access Group Identifier (CAG ID), and/or a Physical Cell Identifier (PCI).

In an embodiment, where receiving, by the AMF entity, the initial NAS message from the UE includes receiving, by the UE, a System Information Block (SIB) from one of the genuine gNB and a fake gNB, where the SIB includes the TAI and/or the CAG ID. Further, the method includes including, by the UE, the TAI and/or the CAG ID in the initial NAS message, where the TAI and/or the CAG ID is selected from one of the genuine gNB and the fake gNB based on a signal strength of the one of the genuine gNB and the fake gNB. Further, the method includes sending, by the UE, the initial NAS message with the TAI and/or the CAG ID to the AMF entity.

In an embodiment, the method includes receiving, by the UE, the NAS accept message or the NAS reject message from the AMF entity. Further, the method includes detecting that the UE is camped on the genuine gNB in response to receiving the NAS accept message from the AMF entity. Further, the method includes detecting that the UE is camped on a fake gNB in response to receiving the NAS reject message from the AMF entity and performing an action(s) to mitigate the MitM attack.

In an embodiment, the initial NAS message from the UE is protected using a NAS security context.

In an embodiment, the action(s) includes performing, by the UE, a cell-reselection procedure, where the UE selects a suitable cell other than a current cell, entering, by the UE, in a 5th Generation Mobility Management (5GMM) deregistered limited service state or a 5GMM deregistered Public Land Mobile Network (PLMN) search state, performing, by the UE, a Radio Resource Control (RRC) re-establishment procedure in the suitable cell, and performing, by the UE, a registration procedure for a mobility registration and a periodic registration update from the suitable cell.

Accordingly, embodiments herein disclose a method for mitigating the MitM attack in the wireless network. The method includes receiving, by the UE, the SIB from one of the genuine gNB and the fake gNB, where the SIB includes the TAI and/or the CAG ID. Further, the method includes including, by the UE, the TAI and/or the CAG ID in the NAS message, where the TAI and/or the CAG ID is selected from one of the genuine gNB and the fake gNB based on the signal strength of one of the genuine gNB and the fake gNB. Further, the method includes sending, by the UE, the initial NAS message with the TAI and/or the CAG ID to the AMF entity.

In an embodiment, the method further comprises receiving, by the UE, at least one of a NAS accept message and a NAS reject message from the AMF entity; and performing, by the UE, one of: detecting that the UE is camped on the genuine gNB in response to receiving the NAS accept message from the AMF entity, or detecting that the UE is camped on a fake gNB in response to receiving the NAS reject message from the AMF entity and performing at least one action to mitigate the MitM attack.

In an embodiment, wherein the at least one action comprises: performing, by the UE, a cell-reselection procedure, wherein the UE selects a suitable cell other than a current cell; entering, by the UE, in a 5th Generation Mobility Management (5GMM) deregistered limited service state or a 5GMM deregistered Public Land Mobile Network (PLMN) search state; performing, by the UE, a Radio Resource Control (RRC) re-establishment procedure in the suitable cell; and performing, by the UE, a registration procedure for a mobility registration and a periodic registration update from the suitable cell.

Accordingly, the embodiments herein provide the AMF entity for mitigating the MitM attack in a wireless network. The AMF entity includes a MitM controller coupled with a processor and a memory. The MitM controller receives the initial NAS message from the UE and/or the N2 message from the genuine gNB. Further, the MitM controller determines the plurality of parameters received in the initial NAS message and the plurality of parameters received in the N2 message. Further, the MitM controller determines whether the plurality of parameters received in the initial NAS message matches with the plurality of parameters received in the N2 message. Further, the MitM controller sends the NAS accept message with appropriate indication to the UE in response to determining that the plurality of parameters received in the initial NAS message matches with the plurality of parameters received in the N2 message. Further, the MitM controller sends the NAS reject message with appropriate error cause value to the UE to mitigate the MitM attack in response to determining that the plurality of parameters received in the initial NAS message does not match with the plurality of parameters received in the N2 message.

Accordingly, the embodiments herein provide the UE for mitigating the MitM attack in a wireless network. The UE includes a MitM controller coupled with a processor and a memory. The MitM controller receives the SIB from the genuine gNB or the fake gNB, where the SIB includes the TAI and/or CAG ID. Further, the MitM controller includes the TAI and/or the CAG ID in the initial NAS message, where the TAI and/or the CAG ID is selected from the genuine gNB or the fake gNB based on a signal strength of the one of the genuine gNB and the fake gNB. Further, the MitM controller sends the initial NAS message with the TAI and/or the CAG ID to the AMF entity.

In an embodiment, the MitM controller is further configured to receive a NAS accept message and a NAS reject message from the AMF entity; and perform one of: detecting that the UE is camped on the genuine gNB in response to receiving the NAS accept message from the AMF entity, or detecting that the UE is camped on a fake gNB in response to receiving the NAS reject message from the AMF entity and performing at least one action to mitigate the MitM attack.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

This invention is illustrated in the accompanying drawings, throughout which like reference letters indicate corresponding parts in the various figures. The embodiments herein will be better understood from the following description with reference to the drawings, in which:

FIG. 1a illustrates a block diagram of an Access and Mobility Management Function (AMF) entity for mitigating a Man in the Middle (MitM) attack in a wireless network, according to an embodiment as disclosed herein;

FIG. 1b illustrates a block diagram of a User Equipment (UE) for mitigating the MitM attack in the wireless network, according to an embodiment as disclosed herein;

FIG. 2 is a sequence diagram illustrating a method for mitigating the MitM attack in the wireless network by sending an error message to the UE when a genuine gNB detects that a plurality of parameters received in an N2 message is not the same as a plurality of parameters broadcasted by the genuine gNB, according to an embodiment as disclosed herein;

FIG. 3 is a sequence diagram illustrating a method for mitigating the MitM attack in the wireless network by sending a reject registration to the UE when the AMF entity detects that a plurality of parameters received in a registration request is not the same as a plurality of parameters broadcasted by the AMF entity, according to an embodiment as disclosed herein;

FIG. 4 is a sequence diagram illustrating a method for mitigating the MitM attack in the wireless network by sending the reject registration to the UE when the genuine gNB detects that a plurality of parameters received in a first protected AS message is not the same as the plurality of parameters broadcasted by the genuine gNB, according to an embodiment as disclosed herein;

FIG. 5 is a sequence diagram illustrating a method for mitigating the MitM attack in the wireless network by sending a protected registration reject to the UE when the AMF entity detects that the plurality of parameters received in the first protected NAS message is not the same as the plurality of parameters broadcasted by the AMF entity, according to an embodiment as disclosed herein;

FIG. 6 is a sequence diagram illustrating a method for mitigating the MitM attack in the wireless network by sending a NAS reject to the UE when the AMF entity detects that the plurality of parameters received in an initial NAS message is not the same as the plurality of parameters broadcasted by the AMF entity, according to an embodiment as disclosed herein;

FIG. 7 is a sequence diagram illustrating a method for mitigating the MitM attack in the wireless network by sending a registration reject to the UE when the AMF entity detects that the plurality of parameters received in a NAS security mode complete is not the same as the plurality of parameters broadcasted by the AMF entity, according to an embodiment as disclosed herein:

FIG. 8 is a sequence diagram illustrating a method for mitigating the MitM attack in the wireless network by sending an RRC reject to the UE when the genuine gNB detects that the plurality of parameters received in an AS security mode complete is not the same as the plurality of parameters broadcasted by the genuine gNB, according to an embodiment as disclosed herein:

FIG. 9 is a sequence diagram illustrating a method for mitigating the MitM attack in the wireless network by sending a NAS security mode command request to the UE, according to an embodiment as disclosed herein; and

FIG. 10 is a sequence diagram illustrating a method for mitigating the MitM attack in the wireless network by sending the registration reject to the UE when the AMF entity detects that the plurality of parameters received in the registration request is not the same as the plurality of parameters broadcasted by the AMF entity, according to an embodiment as disclosed herein.

### DETAILED DESCRIPTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

As is traditional in the field, embodiments may be described and illustrated in terms of blocks which carry out a described function or functions. These blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by firmware. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

The accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings. Although the terms first, second, etc. may be used herein to describe various elements, these elements should not be limited by these terms. These terms are generally only used to distinguish one element from another.

Throughout this document, the term “Fake gNB/eNB” or “False gNB/eNB” are used interchangeably used to represent the false base station present in the network. Throughout this document, the term “AMF” or “AMF entity” are used interchangeably used. The term for example “TAI1” means “PLMN ID+TAC1”. When mentioned gNB broadcasts/transmits TAI1, means gNB broadcasts Public Land Mobile Network Identifier (PLMN ID) and TAC value as 1 in the System Information Block type 1 (SIB1).

Accordingly, embodiments herein disclose a method for mitigating a Man in the Middle (MitM) attack in a wireless network. The method includes receiving, by an Access and Mobility Management Function (AMF) entity, an initial Non-access stratum (NAS) message from a User Equipment (UE) and/or an N2 message from a genuine Next Generation NodeB (gNB). Further, the method includes determining, the AMF entity, a plurality of parameters received in the initial NAS message and a plurality of parameters received in the N2 message. Further, the method includes determining, the AMF entity, whether the plurality of parameters received in the initial NAS message matches with the plurality of parameters received in the N2 message. Further, the method includes sending a NAS accept message with appropriate indication to the UE in response to determining that the plurality of parameters received in the initial NAS message matches with the plurality of parameters received in the N2 message. Further, the method includes sending a NAS reject message with an appropriate error cause value to the UE to mitigate the MitM attack in response to determining that the plurality of parameters received in the initial NAS message does not match with the plurality of parameters received in the N2 message.

Accordingly, embodiments herein disclose a method for mitigating the MitM attack in the wireless network. The method includes receiving, by the UE, the SIB from one of the genuine gNB and a fake gNB, where the SIB includes the TAI and/or the CAG ID. Further, the method includes including, by the UE, the TAI and/or the CAG ID in the NAS message, where the TAI and/or the CAG ID is selected from one of the genuine gNB and the fake gNB based on the signal strength of one of the genuine gNB and the fake gNB. Further, the method includes sending, by the UE, the initial NAS message with the TAI and/or the CAG ID to the AMF entity.

Accordingly, the embodiments herein provide the AMF entity for mitigating the MitM attack in a wireless network. The AMF entity includes a MitM controller coupled with a processor and a memory. The MitM controller receives the initial NAS message from the UE and/or the N2 message from the genuine gNB. Further, the MitM controller determines the plurality of parameters received in the initial NAS message and the plurality of parameters received in the N2 message. Further, the MitM controller determines whether the plurality of parameters received in the initial NAS message matches with the plurality of parameters received in the N2 message. Further, the MitM controller sends the NAS accept message with appropriate indication to the UE in response to determining that the plurality of parameters received in the initial NAS message matches with the plurality of parameters received in the N2 message. Further, the MitM controller sends the NAS reject message with the appropriate error cause value to the UE to mitigate the MitM attack in response to determining that the plurality of parameters received in the initial NAS message does not match with the plurality of parameters received in the N2 message.

Accordingly, the embodiments herein provide the UE for mitigating the MitM attack in a wireless network. The UE includes a MitM controller coupled with a processor and a memory. The MitM controller receives the SIB from the genuine gNB or the fake gNB, where the SIB includes the TAI and/or CAG ID. Further, the MitM controller includes the TAI and/or the CAG ID in the initial NAS message, where the TAI and/or the CAG ID is selected from the genuine gNB or the fake gNB based on a signal strength of the one of the genuine gNB and the fake gNB. Further, the MitM controller sends the initial NAS message with the TAI and/or the CAG ID to the AMF entity.

Unlike existing methods and systems, the proposed method allows the AMF and/or the genuine gNB/eNB to mitigate the Man in the Middle (MitM) attack in the wireless network by comparing the plurality of parameters (e.g. TA1, CAG ID, etc.) received in the message (e.g. initial NAS message, registration request, first protected NAS message) from the User Equipment (UE) and the plurality of parameters (e.g. TA1, CAG ID, etc.) broadcasted/received/stored by the AMF and/or the genuine gNB/eNB. The AMF and/or the genuine gNB/eNB sends the accept message (e.g. NAS accept) or the reject message (e.g. NAS reject, RRC reject or RRC reconfiguration, registration reject, etc.) with the appropriate error cause value to the UE to mitigate the MitM attack.

Unlike existing methods and systems, the proposed method allows to the UE to include the plurality of parameters in the message and send the message to the AMF and/or genuine gNB/eNB. The UE receives the accept message or the reject message with the appropriate error cause value from the AMF and/or the genuine gNB/eNB. Based on the received message from the AMF and/or the genuine gNB/eNB, the UE detects that the UE is camped on the genuine gNB/eNB or the fake gNB/eNB. The UE performs an action(s) (e.g. cell reselection, RRC re-establishment procedure, etc.), when the UE is camped on the fake gNB/eNB, to mitigate the MitM attack. As a result, by selecting the genuine gNB/eNB, the UE can avoid unnecessary UE state transition/signalling and reduce battery power consumption.

Unlike existing methods and systems, the proposed method allows to the UE to send the TAI in an RRC resume request and the gNB/eNB to respond with the TAI in a protected/unprotected response message in response to the resume request. It becomes difficult to launch the attack because it is extremely difficult for an attacker to modify the TAI in both the request and response messages if the response is unprotected. When the UE detects a difference between the TA sent in the RRC resume request message and the TAI of the genuine gNB/eNB received in the protected or unprotected response message, the UE suspects an air interface vulnerability and proceeds to re-establish the RRC connection by going for cell reselection.

Unlike existing methods and systems, the proposed method allows to the UE to initiate emergency services under the worst circumstances. During this time, the UE does not delete the “forbidden TAs list” and can search for an appropriate allowed TA cell to camp on.

Unlike existing methods and systems, the proposed method allows to the UE to add current TAI to a forbidden list but not erase an entire TAT list for a particular time window unless a periodic update has occurred on receiving the registration reject with “cause #15” from the network or switching the UE off and on, or removing and re-inserting a UMTS Subscriber Identity Module (USIM)/a Universal Integrated Circuit Card (UICC) from/in the UE. In other words, the UE should not delete the “Allowed TAIs list” unless the UE receives a new “Allowed TAIs list” with one or more TAI that is not the same as in the “Old Allowed TAIs list.”

Unlike existing methods and systems, the proposed method allows to the UE to maintain a list of mapping between allowed Physical Cell ID (PCI) and CAG ID from Automatic Neighbours Relation (ANR) Table and the TAI for all available neighbouring TAI.

Unlike existing methods and systems, the proposed method allows to the AMF to send the TA of the genuine gNB broadcasting its TA when the UE receives the reject message. The UE determines whether any PCI and CAG ID in the ANR mapping list is linked to the TAI received from the AMF. If not, the UE should add that TA to the “forbidden TAs list” and continue with cell reselection.

Unlike existing methods and systems, the proposed method allows to the UE to maintain a NAS security context as well as an AS security context while also moving out of a cell when an adversary acting as MitM is detected. It means that the UE cannot delete the existing NAS and AS security contexts unless it finds a new genuine cell to camp on.

Unlike existing methods and systems, the proposed method actives the AS security context if the UE performs Radio Link Failure (RLF) procedure instead of RRC state transition and at the same time, the UE moves out of the cell.

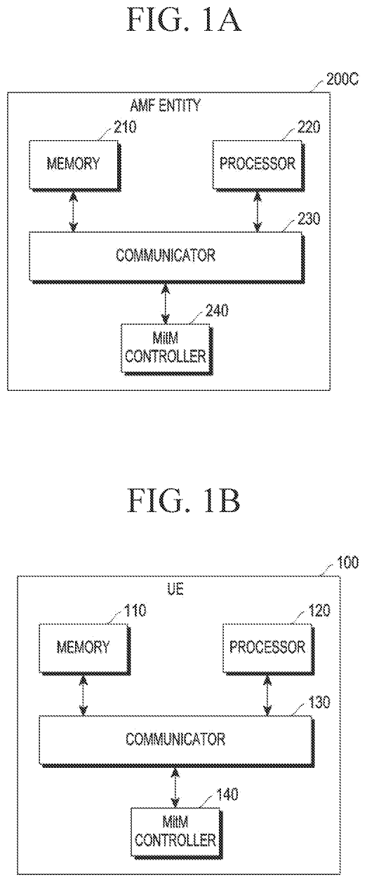

Referring now to the drawings and more particularly to FIGS. 1a through 10, where similar reference characters denote corresponding features consistently throughout the figures, there are shown preferred embodiments.

FIG. 1a illustrates a block diagram of an Access and Mobility Management Function AMF) entity 200C for mitigating the MitM attack in the wireless network, according to an embodiment as disclosed herein.

In an embodiment, the AMF 200C includes a memory 210, a processor 220, a communicator 230, and a MitM controller 240.

In an embodiment, the memory 210 is configured to store a plurality of parameters (e.g., a Tracking Area Identity (TAI), Closed Access Group Identifier (CAG ID), etc.) received in a message (e.g. initial NAS message) from a User Equipment (UE) 100 (not shown in FIG. 1a) and a plurality of parameters (e.g. TA1, CAG ID, etc.) received in a message (e.g. N2 message) from a genuine Next Generation NodeB (gNB) 200B (not shown in FIG. 1a). The memory 210 stores instructions to be executed by the processor 220. The memory 210 may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory 210 may, in some examples, be considered a non-transitory storage medium. The term “non-transitory” may indicate that the storage medium is not embodied in a carrier wave or a propagated signal. However, the term “non-transitory” should not be interpreted that the memory 210 is non-movable. In some examples, the memory 210 can be configured to store larger amounts of information than the memory. In certain examples, a non-transitory storage medium may store data that can, over time, change (e.g., in Random Access Memory (RAM) or cache). The memory 210 can be an internal storage unit or it can be an external storage unit of the AMF entity 200C, a cloud storage, or any other type of external storage.

The processor 220 communicates with the memory 210, the communicator 230, and the MitM controller 240. The processor 220 is configured to execute instructions stored in the memory 210 and to perform various processes. The processor 220 may include one or a plurality of processors, maybe a general-purpose processor, such as a central processing unit (CPU), an application processor (AP), or the like, a graphics-only processing unit such as a graphics processing unit (GPU), a visual processing unit (VPU), and/or an Artificial intelligence (AI) dedicated processor such as a neural processing unit (NPU).

The communicator 230 is configured for communicating internally between internal hardware components and with external devices (e.g. UE, gNodeB, server, etc.) via one or more networks (e.g. Radio technology). The communicator 230 includes an electronic circuit specific to a standard that enables wired or wireless communication.

The MitM controller 240 is implemented by processing circuitry such as logic gates, integrated circuits, microprocessors, microcontrollers, memory circuits, passive electronic components, active electronic components, optical components, hardwired circuits, or the like, and may optionally be driven by firmware. The circuits may, for example, be embodied in one or more semiconductor chips, or on substrate supports such as printed circuit boards and the like.

In an embodiment, the MitM controller 240 receives an initial Non-Access Stratum (NAS) message and/or a message (e.g. a registration request, a first protected NAS message, a NAS security mode complete, etc.) from the UE 100 and/or an N2 message and/or a message (e.g. a registration request, an initial NAS message) from the gNB 200B. Further, the MitM controller 240 determines the plurality of parameters received in the initial NAS message (and/or the message) and the plurality of parameters received in the N2 message (and/or the message). The plurality of parameters includes the TA1, the CAG ID, and a Physical Cell Identifier (PCI). Further, the MitM controller 240 determines whether the plurality of parameters received in the initial NAS message matches with the plurality of parameters received in the N2 message.

Further, the MitM controller 240 sends a NAS accept message with appropriate indication to the UE 100 in response to determining that the plurality of parameters received in the initial NAS message matches with the plurality of parameters received in the N2 message. Further, the MitM controller 240 sends a NAS reject message and/or a message (e.g. RRC reject, RRC reconfiguration, registration reject, protected registration reject, reject message, error message, etc.) with an appropriate error cause value (for example, Cause #15—No suitable cells in tracking area, a new reject cause, Cause #x Serving cell not authorized) to the UE 100 to mitigate the MitM attack in response to determining that the plurality of parameters received in the initial NAS message does not match with the plurality of parameters received in the N2 message.

In an embodiment, the method/functionality described in FIG. 1a is applicable to other network entities (E.g. genuine gNB 200B), not limited to the AMF entity 200C. For example, the genuine gNB 200B compares the plurality of parameters (e.g. TA1, CAG ID, etc.) received in the message (e.g. initial NAS message, registration request, first protected NAS message) from the UE 100 and the plurality of parameters (e.g. TA1, CAG ID, etc.) broadcasted/received/stored by the genuine gNB 200B. The genuine gNB 200B sends the accept message (e.g. NAS accept) or the reject message (e.g. NAS reject, RRC reject or RRC reconfiguration, registration reject, etc.) with appropriate error cause value to the UE 100 to mitigate the MitM attack.

Although the FIG. 1a shows various hardware components of the AMF entity 200C but it is to be understood that other embodiments are not limited thereon. In other embodiments, the AMF entity 200C may include less or more number of components. Further, the labels or names of the components are used only for illustrative purpose and does not limit the scope of the invention. One or more components can be combined together to perform same or substantially similar function to mitigate the MitM attack in the wireless network.

FIG. 1b illustrates a block diagram of the UE 100 for mitigating the MitM attack in the wireless network, according to an embodiment as disclosed herein. Examples of the UE 100 include, but are not limited to a smartphone, a tablet, a Personal Digital Assistance (PDA), an Internet of Things (IoT) device, a wearable device, etc.

In an embodiment, the UE 100 includes a memory 110, a processor 120, a communicator 130, and a MitM controller 140.

In an embodiment, the memory 110 is configured to store the plurality of parameters (e.g. a Tracking Area Identity (TAI), Closed Access Group Identifier (CAG ID), etc.) received in a System Information Block (SIB) from the genuine gNB 200B and/or a fake gNB 200A (not shown in FIG. 1b) and the plurality of parameters (e.g. TA1, CAG ID, etc.) received in the message (e.g. NAS reject message, registration reject, etc.) from the AMF entity 200C (not shown in FIG. 1b). The memory 110 stores instructions to be executed by the processor 120. The memory 110 may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory 110 may, in some examples, be considered a non-transitory storage medium. The term “non-transitory” may indicate that the storage medium is not embodied in a carrier wave or a propagated signal. However, the term “non-transitory” should not be interpreted that the memory 110 is non-movable. In some examples, the memory 110 can be configured to store larger amounts of information than the memory. In certain examples, a non-transitory storage medium may store data that can, over time, change (e.g., in Random Access Memory (RAM) or cache). The memory 110 can be an internal storage unit or it can be an external storage unit of the UE 100, a cloud storage, or any other type of external storage.

The processor 120 communicates with the memory 110, the communicator 130, and the MitM controller 140. The processor 120 is configured to execute instructions stored in the memory 110 and to perform various processes. The processor 120 may include one or a plurality of processors, maybe a general-purpose processor, such as a central processing unit (CPU), an application processor (AP), or the like, a graphics-only processing unit such as a graphics processing unit (GPU), a visual processing unit (VPU), and/or an Artificial intelligence (AI) dedicated processor such as a neural processing unit (NPU).

The communicator 130 is configured for communicating internally between internal hardware components and with external devices (e.g. AMF, gNodeB, server, etc.) via one or more networks (e.g. Radio technology). The communicator 130 includes an electronic circuit specific to a standard that enables wired or wireless communication.

The MitM controller 140 is implemented by processing circuitry such as logic gates, integrated circuits, microprocessors, microcontrollers, memory circuits, passive electronic components, active electronic components, optical components, hardwired circuits, or the like, and may optionally be driven by firmware. The circuits may, for example, be embodied in one or more semiconductor chips, or on substrate supports such as printed circuit boards and the like.

In an embodiment, the MitM controller 140 receives the System Information Block (SIB) from the genuine gNB 200B and the fake gNB 200A, where the SIB includes the TAI and/or the CAG ID. Further, the MitM controller 140 includes the TAI and the CAG ID in the initial NAS message or a message (e.g. NAS security mode complete, registration request, first protected AS message, AS security mode complete, etc.), where the TAI and/or the CAG ID is selected from the genuine gNB 200B or the fake gNB 200A based on a signal strength of the one of the genuine gNB 200B and the fake gNB 200A. Further, the MitM controller 140 sends the initial NAS message or the message with the TAI and/or the CAG ID to the AMF entity 200C.

Further, the MitM controller 140 receives the NAS accept message and the NAS reject message from the AMF entity 200C. Further, the MitM controller 140 detects that the UE 100 is camped on the genuine gNB 200B in response to receiving the NAS accept message from the AMF entity 200C. Further, the MitM controller 140 detects that the UE 100 is camped on the fake gNB 200A in response to receiving the NAS reject message from the AMF entity 200C and performing an action(s) to mitigate the MitM attack. The action(s) includes a cell-reselection procedure, where the UE 100 selects a suitable cell other than a current cell and/or enters in a 5th Generation Mobility Management (5GMM) deregistered limited service state or a 5GMM deregistered Public Land Mobile Network (PLMN) search state and/or performs a Radio Resource Control (RRC) re-establishment procedure in the suitable cell and/or performs a registration procedure for a mobility registration and a periodic registration update from the suitable cell.

Although the FIG. 1b shows various hardware components of the UE 100 but it is to be understood that other embodiments are not limited thereon. In other embodiments, the UE 100 may include less or more number of components. Further, the labels or names of the components are used only for illustrative purpose and does not limit the scope of the invention. One or more components can be combined together to perform same or substantially similar function to mitigate the MitM attack in the wireless network.

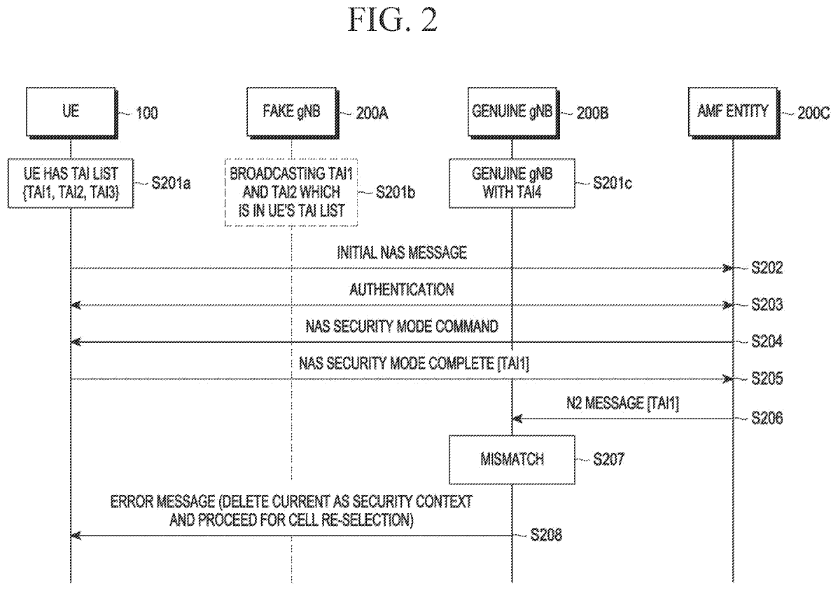

FIG. 2 is a sequence diagram illustrating a method for mitigating the MitM attack in the wireless network by sending an error message to the UE 100 when the genuine gNB 200B detects that the plurality of parameters received in an N2 message is not the same as the plurality of parameters broadcasted by the genuine gNB 200B, according to an embodiment as disclosed herein.

As illustrated in FIG. 2, where the AMF entity 200C receives the initial registration request from the UE 100 and receives the TAI in the NAS message, and the TAT is not in the TAI broadcasted by the genuine gNB 200B. The genuine gNB 200B sends the error message to the UE 100 and requests the UE 100 to delete the current established AS security context and proceed for the cell reselection procedure.

At steps S201a-S201c, the UE 100 is configured with the allowed TAI list (say TAI1, TAI2, TAI3). The fake gNB 200A broadcasts TAI1 and TAI2 same as present in the UE's allowed TAI list, and the genuine gNB 200B broadcasts its TAI i.e., TAI4. At step S202, the UE 100 sends the initial registration message to the AMF entity 200C. At step S203, the UE 100 performs a primary authentication with the network (e.g. AMF entity 200C). At step S204, the AMF entity 200C sends a NAS Security Mode Command to the UE 100.

At step S205, the UE 100 sends a NAS Security Mode Complete to the AMF entity 200C along with the TAI (e.g. TAI1) as received from the broadcasting of the fake gNB 200A. At step S206, the AMF entity 200C sends the received TAI to the genuine gNB. At step S207, the genuine gNB 200B compares the TA (e.g. TAI1) received by the UE 100 with its own TAI (e.g. TA14) and detects a mismatch. At step S208, the genuine gNB 200B sends the error message with an optional indication for deleting the AS security context and proceeding for the cell reselection procedure. The UE 100 may perform the action(s) of the following:
a. The UE 100 performs the cell-reselection procedure and selects a suitable cell other than a current cell in another tracking area. If a protected error message or accept message includes the TAI(s) supported (broadcasted) by the genuine gNB 200B, then the UE 100 may look for the TAI(s) in the list;
b. The UE 100 stores an acquired TAI in the forbidden TAI list;
c. The UE 100 enters in the state 5GMM-DEREGISTERED.LIMITED-SERVICE or optionally 5GMM-DEREGISTERED.PLMN-SEARCH;
d. The UE 100 performs the RRC re-establishment procedure in the newly selected cell;
e. The UE 100 performs the registration procedure for mobility and periodic registration update from the newly selected cell.

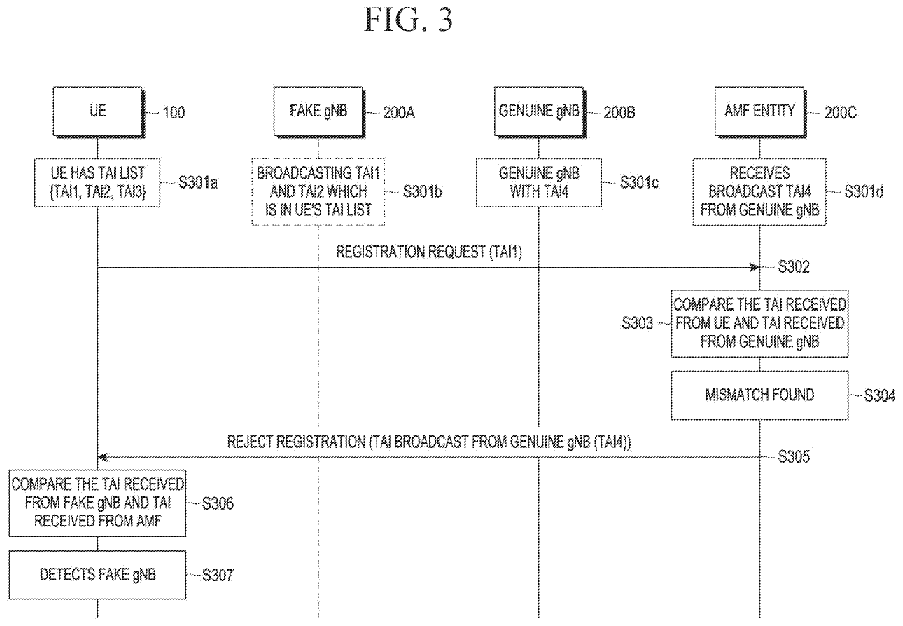

FIG. 3 is a sequence diagram illustrating a method for mitigating the MitM attack in the wireless network by sending the reject registration to the UE 100 when the AMF entity 200C detects that the plurality of parameters received in the registration request is not the same as the plurality of parameters broadcasted by the AMF 200C, according to an embodiment as disclosed herein.

As illustrated in FIG. 3, where the AMF entity 200C receives the registration request from the UE 100 with the current camped TAT and the TAT it received from the genuine gNB 200B does not match. The AMF entity 200C sends the reject message to the UE 100 along with the TAI received from the genuine gNB 200B and the UE 100 to detect the existence of the fake gNB 200B by comparing the TAI received from the fake gNB 200B and the AMF entity 200C.

At steps S301a-S301d, the UE 100 is configured with the allowed TAT list (say TAIL, TAI2, TAI3). The fake gNB 200A broadcasts TAI1 and TAI2 same as present in the UE's allowed TAI list and the genuine gNB 200B broadcasts its TAI i.e., TAI4. The AMF entity 200C receives the TAI broadcasted from the genuine gNB 200B (in the N2 INITIAL UE MESSAGE and/or N2 Notification procedure (RRC state transition notification: UE Notification)). At step S302, the UE 100 sends the registration request message to the AMF entity 200C. An example of the registration message, but are not limited, being any one of a periodic registration update, a mobility registration update, an initial registration, and an emergency registration. The UE 200 includes the TAI (i.e. TAI1) in the request message.

At step S303, the AMF entity 200C compares the TAI (i.e. TAI1) received from the UE 100 and the TAT (i.e. TA14) received from the genuine gNB 200B. At step S304, the AMF entity 200C detects the mismatch if any. At step S305, the AMF entity 200C sends the registration reject message along with the TAI broadcasted from the genuine gNB 200B, in a protected (Integrity protected and/or encrypted) NAS message. If security context is not established or unavailable between the UE 100 and the AMF entity 200C, then the AMF entity 200C sends the registration reject message along with the TAI broadcasted from the genuine gNB 200B, in an unprotected NAS message. In an alternative embodiment, the AMF entity 200C includes an appropriate error cause value (optionally a new error cause value) indicating the UE 100 to move out the cell (for example, indicating the UE 100 to perform reselection of the cell and avoid the current cell).

At step S306, the UE 100 compares the TAI received from the fake gNB 200A and the TAI received from the AMF entity 200C. If there exists any mismatch, then the UE 100 detects the existence of fake gNB 200B at step S307. The UE 100 may perform the action(s) of the following:
a. The UE 100 performs the cell-reselection procedure and selects the suitable cell other than the current cell in another tracking area. If the protected error message or accept message includes the TAI(s) supported (broadcasted) by the genuine gNB 200B, then the UE 100 may look for the TAI(s) in the list,
b. The UE 100 stores the acquired TAI in the forbidden TAI list;
c. The UE 100 enters in the state 5GMM-DEREGISTERED.LIMITED-SERVICE or optionally 5GMM-DEREGISTERED.PLMN-SEARCH;
d. The UE 100 performs the RRC re-establishment procedure in the newly selected cell;
e. The UE 100 performs the registration procedure for mobility and periodic registration update from the newly selected cell.

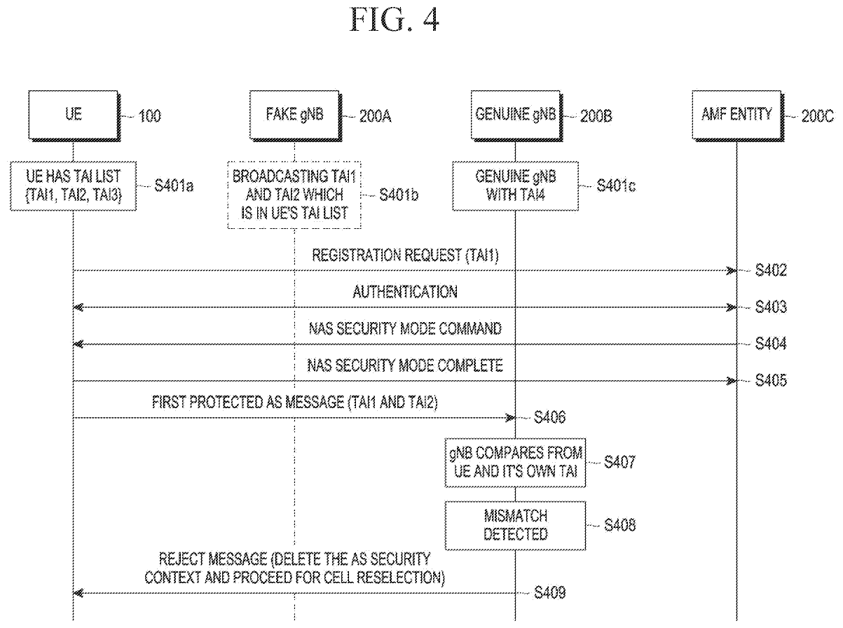

FIG. 4 is a sequence diagram illustrating a method for mitigating the MitM attack in the wireless network by sending the reject registration to the UE 100 when the genuine gNB 200B detects that the plurality of parameters received in a first protected AS message is not the same as the plurality of parameters broadcasted by the genuine gNB 200B, according to an embodiment as disclosed herein.

As illustrated in FIG. 4, where the genuine gNB 200B receives the TAI in the NAS message and the TAT is not in the TAI broadcasted by the genuine gNB 200B, the genuine gNB 200B sends the error message to the UE 100 and requests the UE 100 to delete the current established AS security context and proceed for cell reselection.

At steps S401a-S401c, the UE 100 is configured with the allowed TAT list (say TAI1, TAI2, TAI3). The fake gNB 200A broadcasts the TAI1 and TAI2 same as present in the UE's allowed TAI list and the genuine gNB 200B broadcasts its TAI i.e., TAI4. At step S402, the UE 100 sends the initial registration message to the AMF entity 200C. At step S403, the UE 100 performs the primary authentication with the network. At step S404, the AMF entity 200C sends the NAS Security Mode Command to the UE 100. At step S405, the UE 100 sends the NAS Security Mode Complete to the AMF entity 200C.

At step S406, the UE 100 sends the received TAI to the genuine gNB 200B in the first protected AS message. At step S407, the genuine gNB 200B compares the TAI (i.e. TAIL, TAI2) received by the UE 100 with its own TAI (i.e. TAI4) and detects the mismatch at step (S408). At step S409, the genuine gNB 200B sends the error or reject message with the indication for (optionally) deleting the AS security context and proceeding for cell reselection procedure (not to select the same cell). The UE 100 may perform the action(s) of the following:
a. The UE 100 performs the cell-reselection procedure and selects the suitable cell other than the current cell in another tracking area. If the protected error message or accept message includes the TAI(s) supported (broadcasted) by the genuine gNB 200B, then the UE 100 may look for the TAI(s) in the list;
b. The UE 100 stores the acquired TAT in the forbidden TAI list;
c. The UE 100 enters in the state 5GMM-DEREGISTERED.LIMITED-SERVICE or optionally 5GMM-DEREGISTERED.PLMN-SEARCH;
d. The UE 100 performs the RRC re-establishment procedure in the newly selected cell;
e. The UE 100 performs the registration procedure for mobility and periodic registration update from the newly selected cell.

In another embodiment, in the inactive state, the UE 100 sends the TAI in the RRC resume request and the genuine gNB 200B sends back the TAI in the protected or unprotected response message (in response to the Resume request). It becomes difficult to mount the attack as it is very difficult for an attacker to modify the TAI in both request and response messages (if the response is unprotected). When the UE 100 identifies that the TAI sent in the RRC resume request message and the TAI of the genuine gNB 200B received in the protected or unprotected response message are different, then the UE 100 suspects the vulnerability in the air interface and proceeds re-establishing the RRC connection by going for the cell reselection.

In another embodiment, UE's possibility of camping on the fake gNB 200A is least, because the fake gNB 200A has to operate with the same PCI and same frequency as the nearby genuine gNB 200B which is not possible. Even though the fake gNB 200A succeeds in making the UE 100 to camp on it, the “list of allowed TA” will periodically erase in 12 hours or 24 hours, or when the UE 100 is switched off and restarted. Therefore, the downgraded service will not last for long (only for a time period of 12 or 24 hours).

In an embodiment, if the UE 100 initiate emergency services, then the UE 100 does not erase the “forbidden TA list” and can search for suitable allowed TA cell to camp on.

In another embodiment, upon receiving the registration reject with cause #15, the UE 100 adds the current TAI to the forbidden list and not erases the entire TAI for a particular time window unless a periodic update has occurred or the UE 100 switched off and on or USIM/UICC is removed and re-inserted.

In another embodiment, the UE 100 maintains a list of mapping between an allowed PCI and a CGID from Automatic Neighbour Relation (ANR) Table and the TAI for all available neighbouring TAI. In an embodiment when the UE 100 receives the reject message the AMF entity 200C sends the TAI of the genuine gNB 200B broadcasting its TAI. The UE 100 checks whether any PCI and CGID in the mapping list in ANR is associated with the TAI received from the AMF entity 200C. If not, the UE 100 should add that particular TA to the “forbidden list” and proceed for cell reselection.

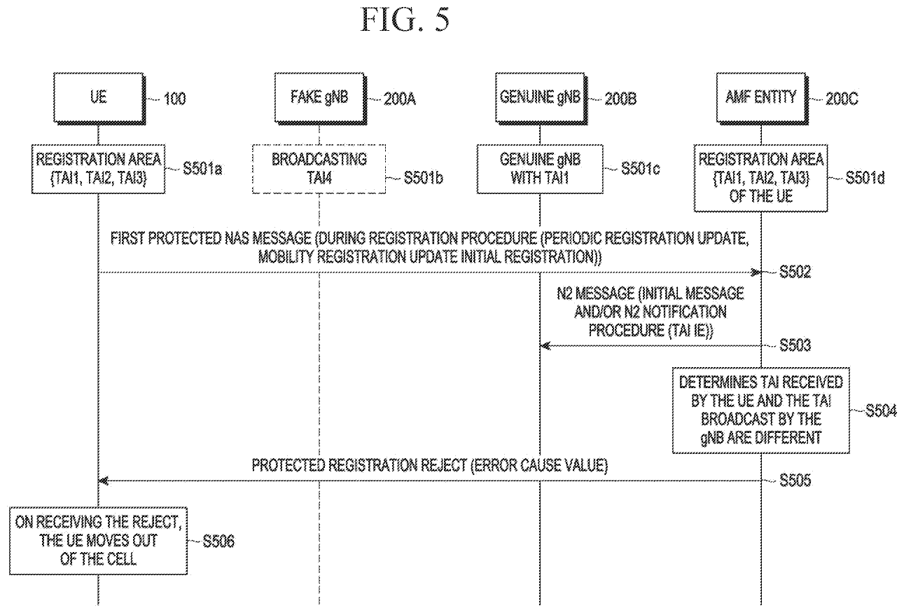

FIG. 5 is a sequence diagram illustrating a method for mitigating the MitM attack in the wireless network by sending a protected registration reject to the UE 100 when the AMF entity 200C detects that the plurality of parameters received in the first protected NAS message is not the same as the plurality of parameters broadcasted by the AMF entity 200C, according to an embodiment as disclosed herein.

As illustrated in the FIG. 5, where the UE 100 includes the TAI in the first protected NAS message, whenever the UE 100 (re)selects a cell and/or when performing registration procedure and the AMF entity 200C checks whether the UE 100 is under the fake gNB 200A which tampered/modified the System Information (SI).

At steps S501a-S501d, the UE 100 may be already configured with the registration area. The fake gNB 200A transmits/broadcast Tracking Area Code 4 (TAC4) (which is TAI4 mentioned in the figure) in its cell. Whereas the genuine gNB 200B transmits/broadcast Tracking Area Code 1 (TAC1) (which is TAI1 mentioned in the figure) in its cell. The AMF entity 200C stored the Registration Area (TAI list) in the UE context if provided to the UE 100. At step S502, the first protected NAS message is the message that is sent after the UE 100 (re)selects a cell and/or during the registration procedure. The UE 100 includes the TA1, which is acquired from the SI broadcasted in the camped cell. The UE 100 includes the TAI as part of the protected (integrity protected and/or encrypted) NAS message. As the UE 100 is under the fake gNB 200A, which acts as the MitM, the UE 100 acquires TAC4 and transmits TAI4 to the AMF entity 200C. In an embodiment, the CAG ID that is acquired from the SI broadcasted in the camped cell is included in the first protected NAS message.

At step S503, the genuine gNB 200B includes the TAI IE (which includes TAI1 value) as part of the N2 Message (for example, N2 Initial UE message) and sends the N2 Message to the AMF entity 200C. In an embodiment, the step S503 is performed before the step S502 (for example, when forwarding the NAS message from the UE 100 to the AMF entity 200C).

At step S504, upon receiving the N2 message, the AMF entity 200C determines whether the UE acquired TAI is the TAI broadcasted by the genuine gNB 200B. If it matches then the AMF entity 200C follows a conventional procedure. If the verification is not successful, i.e. the UE acquired TAI is not matching with the TAI broadcasted by the genuine gNB 200B, then the AMF entity 200C requests the UE 100 to search for the suitable cell other than the current cell, by sending the appropriate error value in the reject message.

In an embodiment, if the verification is not successful, i.e. the UE acquired TAI is not matching with the TAI broadcasted by the genuine gNB 200B, then the AMF entity 200C will request the UE 100 to search for a suitable cell other than the current cell, by sending an appropriate indication in an accept message.

In an embodiment, the protected error message or accept message includes the TA(s) supported (broadcasted) by the genuine gNB 200B.

In an embodiment, the AMF entity 200C determines whether the UE acquired CAG ID is the CAG ID broadcasted by the genuine gNB 200B. If it matches then the AMF entity 200C follows the conventional procedure. If the verification is not successful, i.e. the UE acquired CAG ID is not matching with the CAG ID broadcasted by the genuine gNB 200B, then the AMF entity 200C sends the reject/accept message as detailed above.

At step S505, the AMF entity 200C sends the reject/accept message with the appropriate error cause value/indication to search for the suitable cell other than the current cell to the UE 100. At step S506, upon receiving the error value in the reject message or in the indication in the accept message to search for the suitable cell other than the current cell, the UE 100 performs the action(s) of the following.
a. The UE 100 performs the cell-reselection procedure and selects the suitable cell other than the current cell in another tracking area. If the protected error message or accept message includes the TAI(s) supported (broadcasted) by the genuine gNB 200B, then the UE 100 may look for the TAI(s) in the list,
b. The UE 100 stores the acquired TAI in the forbidden TAI list;
c. The UE 100 enters in the state 5GMM-DEREGISTERED.LIMITED-SERVICE or optionally 5GMM-DEREGISTERED.PLMN-SEARCH;
d. The UE 100 performs the RRC re-establishment procedure in the newly selected cell;
e. The UE 100 performs the registration procedure for mobility and periodic registration update from the newly selected cell.

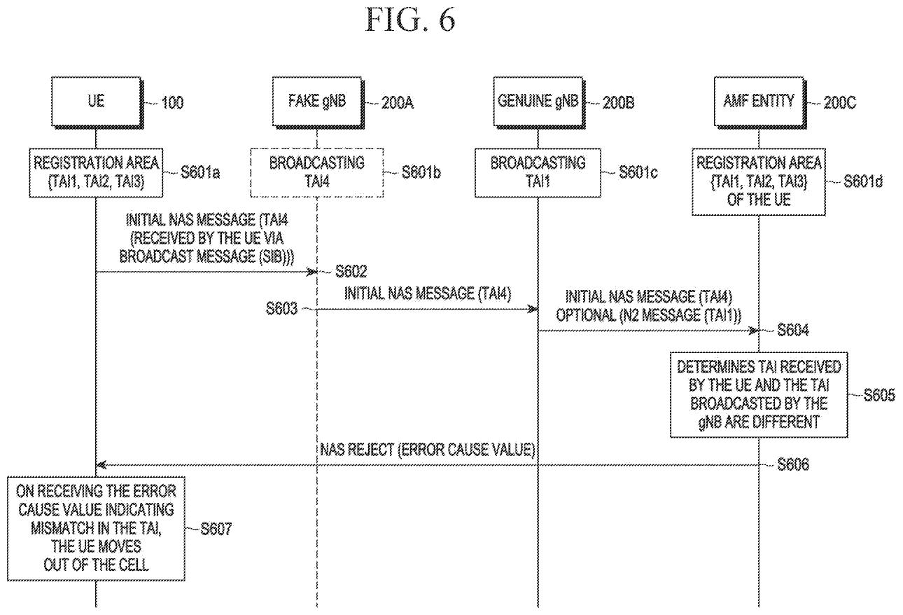

FIG. 6 is a sequence diagram illustrating a method for mitigating the MitM attack in the wireless network by sending the NAS reject to the UE 100 when the AMF entity 200C detects that the plurality of parameters received in the initial NAS message is not the same as the plurality of parameters broadcasted by the AMF entity 200C, according to an embodiment as disclosed herein.

As illustrated in FIG. 6, where the UE 100 includes the TAI in the initial NAS message and the AMF entity 200C checks whether the UE 100 is under the fake gNB 200A which tampered/modified the System Information (SI).

At steps S601a-S601d, the UE 10 may be already configured with the registration area. The fake gNB 200A transmits/broadcasts a TAC (i.e.TAC4) (which is TAI4 mentioned in the figure) in its cell. Whereas the genuine gNB 200B transmits/broadcasts a TAC (i.e. TAC1) (which is TAI1 mentioned in the figure) in its cell. The AMF entity 200C stores the registration area (TAI list) in the UE's context, if provided to the UE 100. At step S602, the initial NAS message is the first NAS message that is sent after the UE's transit from the idle state. The UE 100 includes the TA1, which is acquired from the SI broadcasted in the camped cell. The UE 100 includes the TAI as part of the ciphered initial NAS message. As the UE 100 is under the fake gNB 200A, which acts as the MitM, the UE 100 acquires the TAC4 and transmits the TAI4 to the AMF entity 200C.

At step S603, the fake gNB 200A, which acts as the MitM forwards the protected TAI4 to the genuine gNB 200B. At step S604, on receiving the initial NAS message, the genuine gNB 200B includes the TAI IE (which includes TAI1 value) as part of the N2 message (for example, N2 Initial UE message) and sends the N2 message to the AMF entity 200C which includes the initial NAS message from the UE 100.

At step S605, on receiving the N2 message, the AMF entity 200C determines whether the UE acquired TAI is the TAI broadcasted by the genuine gNB 200B. If it matches then the AMF entity 200C follows the conventional procedure. If the verification is not successful, means the UE acquired TAI is not matching with the TAI broadcasted by the genuine gNB 200B, then the AMF entity 200C will request the UE 100 to search for the suitable cell other than the current cell, by sending the appropriate error value in the reject message.

In an embodiment, if the verification is not successful, means the UE acquired TAI is not matching with the TAI broadcasted by the genuine gNB 200B, then the AMF entity 200C will request the UE 100 to search for the suitable cell other than the current cell, by sending the appropriate indication in the accept message.

In an embodiment, the protected error message or the protected accept message include the TAI(s) supported (broadcasted) by the genuine gNB 200B.

At step S606, the AMF entity 200C sends the reject/accept message with the appropriate error cause value/indication to search for the suitable cell other than the current cell to the UE 100. At step S607, on receiving error value in the reject message or in the indication in the accept message to search for the suitable cell other than the current cell. The UE 100 performs the action(s) of the following.
a. The UE 100 performs cell-reselection procedure and selects the suitable cell other than the current cell in another tracking area. If the protected error message or accept message includes the TAI(s) supported (broadcasted) by the genuine gNB 200B, then the UE 100 may look for the TAI(s) in the list;
b. The UE 100 stores the acquired TAI in the forbidden TAI list;
c. The UE 100 enters in the state 5GMM-DEREGISTERED.LIMITED-SERVICE or optionally 5GMM-DEREGISTERED.PLMN-SEARCH;
d. The UE 100 performs the RRC re-establishment procedure in the newly selected cell;
e. The UE 100 performs the registration procedure for mobility and periodic registration update from the newly selected cell.

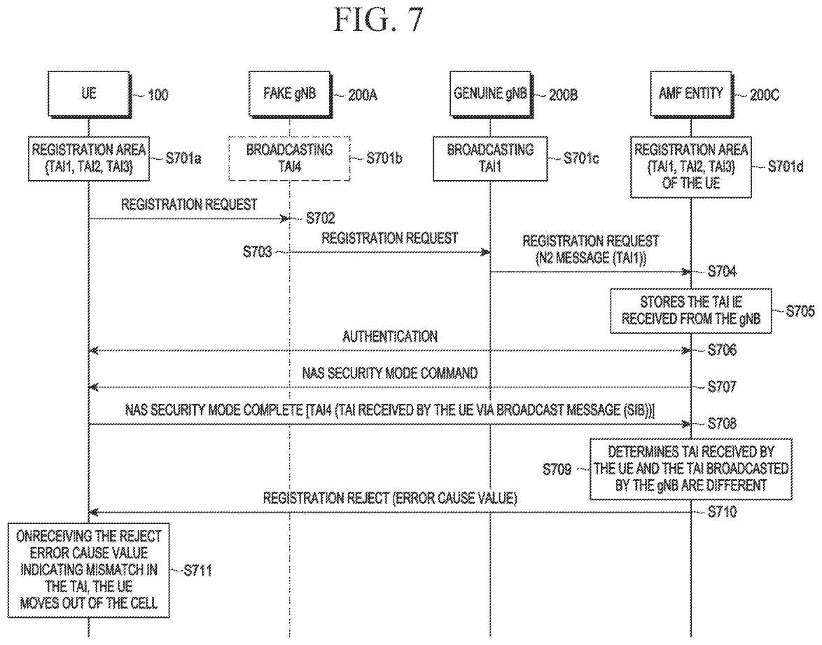

FIG. 7 is a sequence diagram illustrating a method for mitigating the MitM attack in the wireless network by sending the registration reject to the UE 100 when the AMF entity 200C detects that the plurality of parameters received in the NAS security mode complete is not the same as the plurality of parameters broadcasted by the AMF entity 200C, according to an embodiment as disclosed herein.

As illustrated in the FIG. 7, where the UE 100 includes the TAI in the NAS SMC complete message and the AMF entity 200C checks whether the UE 100 is under the fake gNB 200A which tampered/modified the SI.

At steps S701a-S701d, the UE 100 may be already configured with the registration area. The fake gNB 200A transmits/broadcasts the TAC (i.e. TAC4) (which is TAI4 mentioned in the figure) in its cell. Whereas the genuine gNB 200B transmits/broadcasts the TAC (i.e. TAC1) (which is TAI1 mentioned in the figure) in its cell. The AMF entity 200c stored the registration area (TAI list) in the UE's context, if provided to the UE 100.

At steps S702-S703, the UE 100 sends the registration request to the AMF entity 200C, the fake gNB 200A acting as MitM forwards the registration request message to the genuine gNB 200B. At step S704, the genuine gNB 200B forwards the registration request to the AMF entity 200C. The genuine gNB 200B includes the TAI IE (which includes TAI1 value) as part of the N2 Message (for example, N2 Initial UE message) and sends the N2 Message to the AMF entity 200C. At step S705, the AMF entity 200C on receiving the TAI IE from the genuine gNB 200B should store the TAI received. At step S706, the UE 100 performs mutual authentication with the network.

At step S707, the AMF entity 200C sends the NAS Security Mode Command message to the UE 100 for establishing the NAS security context. At step S708, after establishing the NAS security context the UE 100 sends the TAI4 which is the TAI that received via broadcasted message (SIB in the protected NAS Security Mode Complete message. At step S709, the AMF entity 200C compares the TAI received from the genuine gNB 200B and the TAI received from the UE 100. The AMF entity 200C determines that TA received by the UE 100 and the TA broadcasted by the genuine gNB 200B are different.

At step S710, the AMF entity 200C sends the registration reject message with the appropriate error cause value/indication to search for the suitable cell other than the current cell to the UE 100. At step S711, upon receiving the error value in the reject message or in the indication in the accept message to search for the suitable cell other than the current cell. The UE 100 performs the action(s) of the following:
a. The UE 100 performs cell-reselection procedure and selects the suitable cell other than the current cell in another tracking area. If the protected error message or accept message includes the TAI(s) supported (broadcasted) by the genuine gNB 200B, then the UE 100 may look for the TAI(s) in the list;
b. The UE 100 stores the acquired TAI in the forbidden TAI list;
c. The UE 100 enters in the state 5GMM-DEREGISTERED.LIMITED-SERVICE or optionally 5GMM-DEREGISTERED.PLMN-SEARCH;
d. The UE 100 performs the RRC re-establishment procedure in the newly selected cell;
e. The UE 100 performs the registration procedure for mobility and periodic registration update from the newly selected cell.

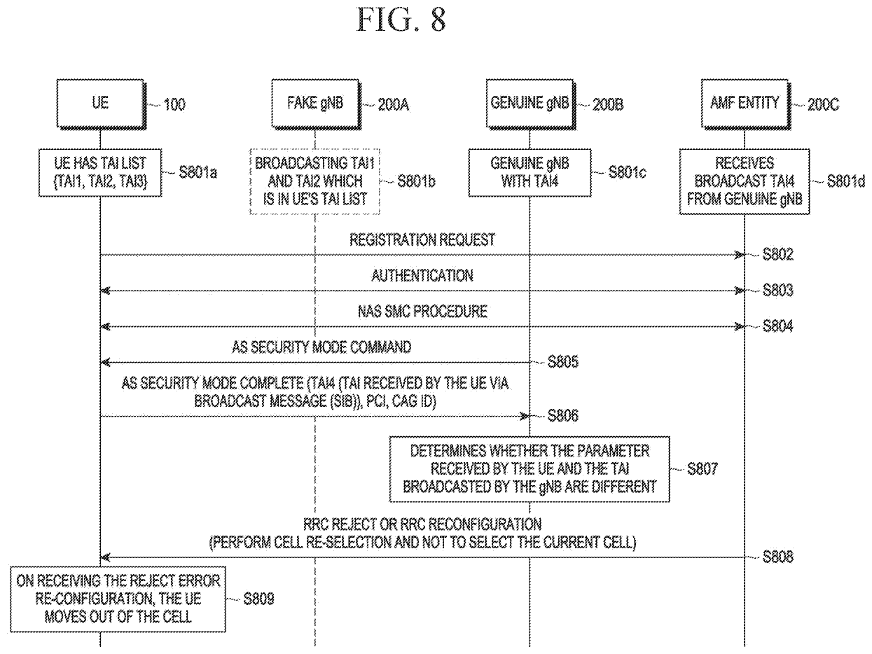

FIG. 8 is a sequence diagram illustrating a method for mitigating the MitM attack in the wireless network by sending the RRC reject to the UE 100 when the genuine gNB 200B detects that the plurality of parameters received in the AS security mode complete is not the same as the plurality of parameters broadcasted by the genuine gNB 200B, according to an embodiment as disclosed herein.

As illustrated in the FIG. 8, where the UE 100 includes the TAI in the AS SMC complete message and the AMF entity 200C checks whether the UE 100 is under the fake gNB 200A which tampered/modified the SI.

At steps S801a-S801d, the UE 100 may be already configured with the registration area. The fake gNB 200B transmits/broadcasts the TAC (i.e. TAC4) (which is TAI4 mentioned in the figure) in its cell. Whereas the genuine gNB 200B transmits/broadcasts the TAC (i.e. TAC1) (which is TAI1 mentioned in the figure) in its cell. The AMF stores the registration area (TAI list) in the UE's context, if provided to the UE 100.

At step S802, the UE 100 sends the registration request to the AMF entity 200C. At step S803, the UE 100 performs the mutual authentication with the network. At step S804, the UE 100 and the AMF entity 200C performs the NAS SMC procedure and establishes the NAS security context. At step S805, the genuine gNB 200B sends the AS security mode command message request for establishing the AS security context.

At step S806, upon completion of the AS SMC, the UE 100 sends the AS security mode complete message including the TAI4 which is the TAI that is received via broadcasted message (SIB) along with the parameters such as PCI and CAG ID (optionally). At step S807, the genuine gNB 200B compares the TA1, PCI, and CAG ID that is broadcasted by the genuine gNB 200B with the one received by the UE 100, and determines the mismatch. At step S808, on determining that the parameter received by the UE 100 and the one broadcasted by the genuine gNB 200B are different, the genuine gNB 200B sends the RRC reject/RRC reconfiguration message to the UE 100 including the appropriate error cause/indication to search for the suitable cell other than the current cell to the UE 100.

In another embodiment, the genuine gNB 200B should include the TA that is broadcasted by the genuine gNB 200B in the error indication sent in the RRC reject/RRC reconfiguration message.

At step S809, upon receiving error value in reject message or in an indication in the accept message to search for a suitable cell other than the current cell. The UE 100 performs the action(s) of the following:
a. The UE 100 performs cell-reselection procedure and selects the suitable cell other than the current cell in another tracking area. If the protected error message or accept message includes the TAI(s) supported (broadcasted) by the genuine gNB 200B, then the UE 100 may look for the TAI(s) in the list;
b. The UE 100 stores the acquired TA in the forbidden TAI list;
c. The UE 100 enters in the state 5GMM-DEREGISTERED.LIMITED-SERVICE or optionally 5GMM-DEREGISTERED.PLMN-SEARCH;
d. The UE 100 performs the RRC re-establishment procedure in the newly selected cell;
e. The UE 100 performs the registration procedure for mobility and periodic registration update from the newly selected cell.

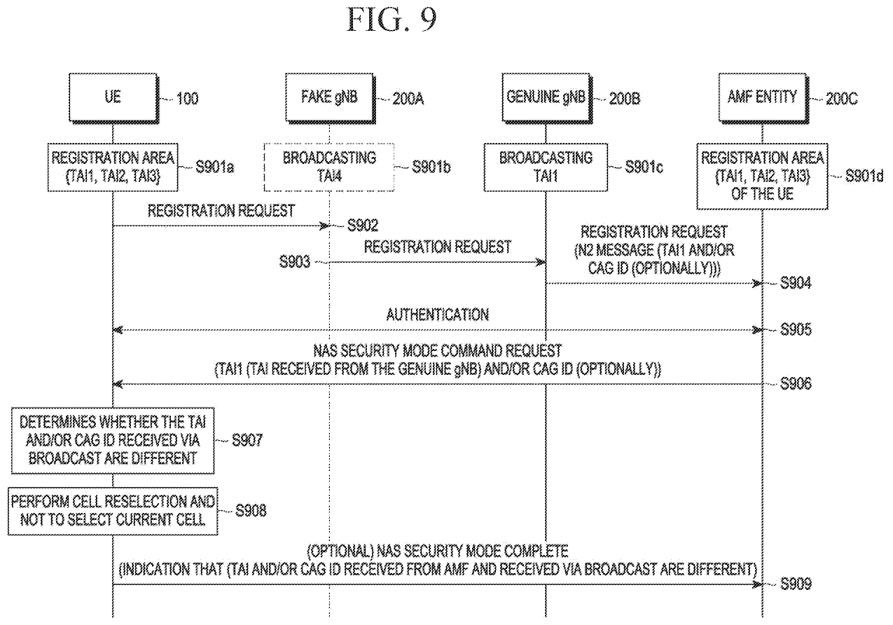

FIG. 9 is a sequence diagram illustrating a method for mitigating the MitM attack in the wireless network by sending the NAS security mode command request to the UE 100, according to an embodiment as disclosed herein.

As illustrated in the FIG. 9, where the AMF entity 200C includes the TAI received from the genuine gNB 200B in the NAS SMC complete message and the UE 100 checks whether there is the fake gNB 200A that tampered/modified the SI.

At steps S901a-S901d, the UE 100 may be already configured with the registration area. The fake gNB 200A transmits/broadcasts the TAC (i.e. TAC4) (which is TAI4 mentioned in the figure) in its cell. Whereas the genuine gNB 200B transmits/broadcasts the TAC (i.e. TAC1) (which is TAI1 mentioned in the figure) in its cell. The AMF entity 200C stored the registration area (TAI list) in the UE's context, if provided to the UE 100.

At steps S902-S903, the UE 100 sends the registration request to the AMF entity 200C, the fake gNB 200A acting as MitM forwards the registration request message to the genuine gNB 200B. At step S904, the genuine gNB 200B forwards the registration request to the AMF entity 200C. The genuine gNB 200B includes the TAI IE (which includes TAI1 value) and/or CAG ID (optionally) as part of the N2 Message (for example, N2 Initial UE message) and sends the N2 Message to the AMF entity 200C.

At step S905, the UE 100 and the AMF entity 200C performs the authentication. At step S906, the AMF entity 200C sends the NAS Security Mode Command message to the UE 100 for establishing the NAS security context. In the NAS SMC message, the AMF entity 200C includes the TAI (TAI1 received from genuine gNB and/or CAG ID).

At step S907, the UE 100 compares the TAI and/or CAG ID received by the UE 100 from the broadcasting fake gNB 200A and the one received from the AMF entity 200C. At step S908, upon determining that the parameter received from the UE 100 and the one broadcasted by the genuine gNB 200B are different. The UE 100 performs the action(s) of the following:
a. The UE 100 performs cell-reselection procedure and selects the suitable cell other than the current cell in another tracking area. If the protected error message or accept message includes the TAI(s) supported (broadcasted) by the genuine gNB 200B, then the UE 1X) may look for the TAI(s) in the list;
b. The UE 100 stores the acquired TAI in the forbidden TAI list;
c. The UE 100 enters in the state 5GMM-DEREGISTERED.LIMITED-SERVICE or optionally 5GMM-DEREGISTERED.PLMN-SEARCH;
d. The UE 100 performs the RRC re-establishment procedure in the newly selected cell;
e. The UE 100 performs the registration procedure for mobility and periodic registration update from the newly selected cell.

At step S909, alternatively, the UE 100 sends the NAS SMC reject including the appropriate error cause/indication about the mismatch.

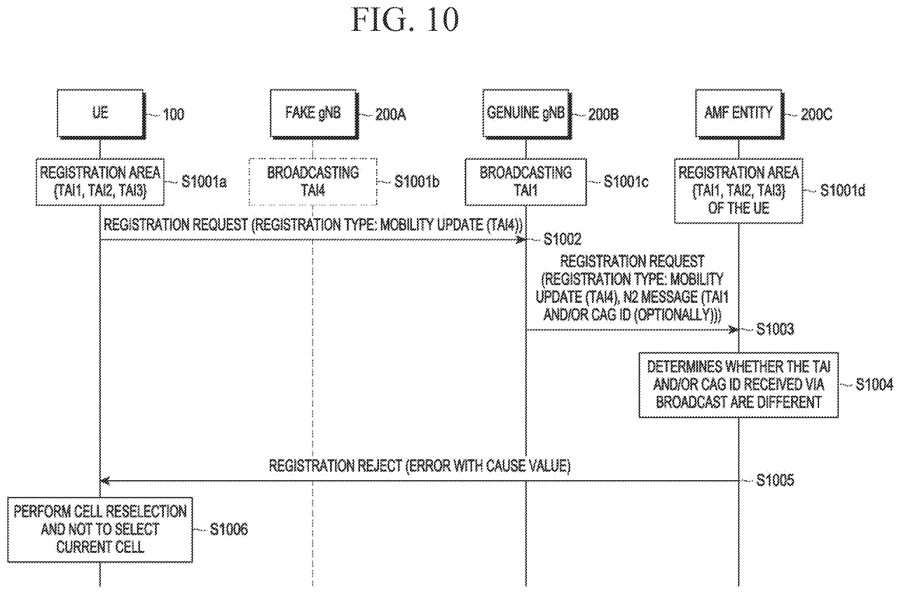

FIG. 10 is a sequence diagram illustrating a method for mitigating the MitM attack in the wireless network by sending a registration reject to the UE 100 when the AMF entity 200C detects that the plurality of parameters received in a registration request is not the same as the plurality of parameters broadcasted by the AMF entity 200C, according to an embodiment as disclosed herein.

As illustrated in FIG. 10, where the AMF entity 200C checks both whether the UE 100 is in authorized TAI and TAI received from the genuine gNB 200B and indicates the UE 100 with the reject message about the presence of a fake gNB 200A which tampered/modified the System Information (SI).

At steps S1001a-S10001d, the UE 100 may be already configured with the registration area. The fake gNB 200A transmits/broadcasts the TAC (i.e. TAC4) (which is TAI4 mentioned in the figure) in its cell. Whereas the genuine gNB 200B transmits/broadcasts the TAC (i.e. TAC1) (which is TAI1 mentioned in the figure) in its cell. The AMF entity 200C stored the registration area (TAI list) in the UE's context, if provided to the UE 100.

At steps S1002, the UE 100 sends the registration request to the AMF entity 200C including the registration type as mobility update and the TAI4 received from the SI broadcasted by the fake gNB 200A, the fake gNB 200A acting as MitM forwards the registration request message to the genuine gNB 200B. At steps S1003, the genuine gNB 200B forwards the registration request to the AMF entity 200C. The genuine gNB 200B includes, in addition, the TAI IE (which includes TAI1 value)) and/or CAG ID (optionally) as part of the N2 message (for example, N2 Initial UE message) and send the N2 message to the AMF entity 200C.

At steps S1004, the AMF entity 200C compares the TAI and/or CAG ID received by it (the AMF entity 200C) from the broadcasting genuine gNB 200B and the one received from the UE 100. At steps S1005, on determining that the parameter received from the UE 100 and the one broadcasted by the genuine gNB 200B are different then the AMF entity 200C sends the registration reject including the appropriate error cause/indication about the mismatch. At steps S1006, upon receiving the registration reject from the AMF entity 200C. The UE 100 performs the action(s) of the following:
a. The UE 100 performs cell-reselection procedure and selects the suitable cell other than the current cell in another tracking area. If the protected error message or accept message includes the TAI(s) supported (broadcasted) by the genuine gNB 200B, then the UE 100 may look for the TAI(s) in the list;
b. The UE 100 stores the acquired TAI in the forbidden TAI list;
c. The UE 100 enters in the state 5GMM-DEREGISTERED.LIMITED-SERVICE or optionally 5GMM-DEREGISTERED.PLMN-SEARCH;
d. The UE 100 performs the RRC re-establishment procedure in the newly selected cell;
e. The UE 100 performs the registration procedure for mobility and periodic registration update from the newly selected cell.

The various actions, acts, blocks, steps, or the like in the sequence diagrams (FIG. 2 to FIG. 10) may be performed in the order presented, in a different order, or simultaneously. Further, in some embodiments, some of the actions, acts, blocks, steps, or the like may be omitted, added, modified, skipped, or the like without departing from the scope of the invention.

The embodiments disclosed herein can be implemented using at least one hardware device and performing network management functions to control the elements.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the embodiments as described herein.

1. A method performed by an access and mobility management function (AMF) entity in a wireless network, the method comprising:
receiving an initial non-access stratum (NAS) message from a user equipment (UE) and an N2 message from a genuine base station;
identifying a plurality of parameters received in the initial NAS message, and a plurality of parameters received in the N2 message;
determining whether the plurality of parameters received in the initial NAS message match with the plurality of parameters received in the N2 message; and
performing one of:
sending a NAS accept message with indication to the UE in response to identifying that the plurality of parameters received in the initial NAS message match with the plurality of parameters received in the N2 message; or
sending a NAS reject message with an error cause value to the UE to mitigate a man in the middle (MitM) attack in response to identifying that the plurality of parameters received in the initial NAS message do not match with the plurality of parameters received in the N2 message.

2. The method of claim 1, further comprising
storing at least one of the plurality of parameters received in the initial NAS message and the plurality of parameters received in the N2 message.

3. The method of claim 1, wherein a plurality of parameters associated with at least one of the initial NAS message and the N2 message comprise at least one of a tracking area identity (TAI), a closed access group identifier (CAG ID), and a physical cell identifier (PCI).

4. The method of claim 1, wherein the initial NAS message is protected based on a NAS security context.

5. A method performed by a user equipment (UE) in a wireless network, the method comprising:
receiving a system information block (SIB) from one of a genuine base station and a fake base station, wherein the SIB comprises at least one of a tracking area identity (TAI), and a closed access group identifier (CAG ID);
including the at least one of the TAI and the CAG ID in an initial non-access stratum (NAS) message, wherein the at least one of the TAI and the CAG ID is selected by one of the genuine base station and the fake base station based on a signal strength of the one of the genuine base station and the fake base station; and
sending the initial NAS message with the at least one of the TAI and the CAG ID to an access and mobility management function (AMF) entity.

6. The method of claim 5, further comprising:
receiving at least one of a NAS accept message and a NAS reject message from the AMF entity; and
performing one of:
detecting that the UE is camped on the genuine base station in response to receiving the NAS accept message from the AMF entity, or
detecting that the UE is camped on the fake base station in response to receiving the NAS reject message from the AMF entity and performing at least one action to mitigate a man in the middle (MitM) attack.

7. The method of claim 6, wherein performing the at least one action comprises:
performing a cell-reselection procedure, and selecting a suitable cell other than a current cell;
entering a 5th generation mobility management (5GMM) deregistered limited service state or a 5GMM deregistered public land mobile network (PLMN) search state;
performing a radio resource control (RRC) re-establishment procedure in the suitable cell; and
performing a registration procedure for a mobility registration and a periodic registration update from the suitable cell.

8. An access and mobility management function (AMF) entity in a wireless network, comprising:
a memory;
a processor; and
a man in the middle (MitM) controller, operably connected to the memory and the processor, configured to:
receive an initial non-access stratum (NAS) message from a user equipment (UE) and an N2 message from a genuine base station;
identify a plurality of parameters received in the initial NAS message, and a plurality of parameters received in the N2 message;
determine whether the plurality of parameters received in the initial NAS message match with the plurality of parameters received in the N2 message; and
perform one of:
sending a NAS accept message with indication to the UE in response to identifying that the plurality of parameters received in the initial NAS message match with the plurality of parameters received in the N2 message; or
sending a NAS reject message with an error cause value to the UE to mitigate a man in the middle (MitM) attack in response to identifying that the plurality of parameters received in the initial NAS message do not match with the plurality of parameters received in the N2 message.

9. The AMF entity of claim 8, wherein the MitM controller is further configured to store at least one of the plurality of parameters received in the initial NAS message and the plurality of parameters received in the N2 message.

10. The AMF entity of claim 8, wherein a plurality of parameters associated with at least one of the initial NAS message and the N2 message comprise at least one of a tracking area identity (TAI), a closed access group identifier (CAG ID), and a physical cell identifier (PCI).

11. The AMF entity of claim 8, wherein the initial NAS message is protected based on a NAS security context.

12. A user equipment (UE) in a wireless network, comprising:
a memory;
a processor; and
a man in the middle (MitM) controller, operably connected to the memory and the processor, configured to:
receive a system information block (SIB) from one of a genuine base station and a fake base station, wherein the SIB comprises the at least one of a tracking area identity (TAI), and a closed access group identifier (CAG ID);
include the at least one of the TAI and the CAG ID in an initial non-access stratum (NAS) message, wherein the at least one of the TAI and the CAG ID is selected by one of the genuine base station and the fake base station based on a signal strength of the one of the genuine base station and the fake base station; and
send the initial NAS message with the at least one of the TAI and the CAG ID to an access and mobility management function (AMF) entity.

13. The UE of claim 12, wherein the MitM controller is further configured to:
receive at least one of a NAS accept message and a NAS reject message from the AMF entity; and
perform one of:
detecting that the UE is camped on the genuine base station in response to receiving the NAS accept message from the AMF entity, or
detecting that the UE is camped on the fake base station in response to receiving the NAS reject message from the AMF entity and performing at least one action to mitigate the MitM attack.

14. The UE of claim 12, wherein the MitM controller is configured to:
perform a cell-reselection procedure, and select a suitable cell other than a current cell,
enter a 5th generation mobility management (5GMM) deregistered limited service state or a 5GMM deregistered public land mobile network (PLMN) search state,
perform a radio resource control (RRC) re-establishment procedure in the suitable cell, and
perform a registration procedure for a mobility registration and a periodic registration update from the suitable cell.
